(19) United States
(12) Patent Application Publication
(10) Pub. No.: US 2018/0357729 A1
(43) Pub. Date: Dec. 13, 2018

(54) USER INTERFACE FOR MONETIZING SOCIAL AFFIRMATIONS

(71) Applicant: Heart Cup, Inc., Yucaipa, CA (US)

(72) Inventors: Robert C. Farnham, San Clemente, CA (US); Philip R. McAndrew, San Clemente, CA (US)

(21) Appl. No.: 16/003,321

(22) Filed: Jun. 8, 2018

Related U.S. Application Data
(60) Provisional application No. 62/518,323, filed on Jun. 12, 2017.

(51) Int. Cl. G06Q 50/00; G06Q 20/06; G06Q 30/02

(52) U.S. Cl. CPC G06Q 50/01; H04L 67/306; G06Q 30/0279; G06Q 20/065

(57) ABSTRACT

A method of generating a graphical user interface for monetizing social affirmations includes displaying, on a user feed of the graphical user interface, a post including summary information of a project for which monetary contributions are accepted, the post including a link to a project details page including detailed information of the project that is more detailed than the summary information, and displaying, within or adjacent to the post, a social affirmation button by which a user of the graphical user interface may indicate an affirmation of the project, the affirmation causing a fixed amount of a virtual currency to be transferred from a store of virtual currency associated with the user to a store of virtual currency associated with the project.

### CROSS-REFERENCE TO RELATED APPLICATIONS

This application relates to and claims the benefit of U.S. Provisional Application No. 62/518,323 filed Jun. 12, 2017 and entitled “MONETIZATION OF SOCIAL AFFIRMATIONS PLATFORM/METHODOLOGY,” the entire disclosure of which is hereby wholly incorporated by reference.

### STATEMENT RE: FEDERALLY SPONSORED RESEARCH/DEVELOPMENT

Not Applicable

### BACKGROUND

### 1. Technical Field

The present disclosure relates generally to online social networking services as well as online crowdfunding platforms and, more specifically, to a graphical user interface for monetizing social affirmations in the context of such services and platforms.

### 2. Related Art—Social Networking and Social Media

Online, web-based social networking and social media sites are popular across a wide demographic of users, and in general pervasive in societies with Internet access. At the most basic level, social networking involves connecting users of an online network. Social media only slightly differs from social networking in that the focus of the platform is on the delivery of media instead of relationships between users. For the most part, websites dedicated to social media usually contain a social network and vice versa. For the sake of this disclosure, the terms social networking and social media—due to their significant overlap—will be used interchangeably wherein the meaning of both terms references websites or platforms where users have the ability to connect with one another for the purpose of sharing media, information and content, socially. On a social networking platform, a user will typically create an account, build a unique profile, connect with other users, share information by means of text, photo, and video content, and provide feedback on others content in the forms of affirmations and written communication. For the profile, basic data such as: name, birthdate, employment, schools attended, personal relationships and network of friends are usually included. Access to a user's shared information may be limited to other users that have been approved or connected with the user's account, but depending on preference, information may be made available to all users of the social networking platform. Thus, a group of independent users can connect online and a variety of information and digital content can be exchanged and shared within their constructed social network within the platform.

Facebook® is the most popular social networking website online and currently boasts a global user base of over a billion. Facebook's® feature set continues to develop and seeks to further engage people into their online community. Users have the ability to connect with friends, stay in touch with friends, and enter discussions on any topic that the community is discussing or has discussed. Facebook® has built powerful integration capabilities across other social sites, blogs, and webpages to facilitate content sharing and promotion. Facebook® developed and made popular a user's “feed” which is a single location or newsfeed where the content from your network, advertisements, and updates from the businesses that you follow are shared in chronological order. Another Facebook® feature that is nearly ubiquitous within social networking sites is the “like” functionality. This functionality allows users to affirm content they “like.” Facebook's® “like” functionality is an example of the term “social affirmation” or “social reaction” as used in the present disclosure. These social affirmations include, but are not limited to, the visual representation that a user has affirmed or responded to the posted content. Recently, the “like” functionality has expanded to a small range of emojis including happy, sad, angry, etc. This has given users more flexibility in the emotional response that they can attribute to a particular piece of content. As related to this disclosure, social response and affirmation are used synonymously.

Although Facebook® is a clear leader in the social networking space and arguably has the most recognized social affirmation system, the inventor has recognized that there are some deficiencies in the platform concerning social affirmations. The first is that content does not have a way to be directly monetized by Facebook®. Regardless of content quality, shares, likes, or any other data point, the income generated from Facebook® is indirectly generated. That is to say that a post of valuable information will result in views and potentially be shared virally, but the actual profit made from that content is dependent upon users making a purchase or contributing money outside of the Facebook® platform. Facebook® merely offers a platform from which to broadcast and advertise.

LinkedIn®, which specializes in professional networking and career development is similar to Facebook® regarding social affirmations. On LinkedIn®, users create profiles which can serve as a professional resume. Similar to Facebook®, LinkedIn® has a feed that showcases the content from groups (typically professional in nature), organizations, connections, advertisements, and influential people/authors the user is “following.” LinkedIn® also has the ability to like, share, and comment on content. The inventor has recognized that LinkedIn® has left a lot to be desired in the area of content monetization and even authentic communication between professionals. In many ways the site has become a sales and recruiting tool to identify and approach prospects to generate business. As such, the content that is produced and shared on LinkedIn® is not directly compensable.

Another social networking site is Twitter®. On Twitter®, posts are limited in length to 140 characters and can be viewed by anyone who “follows” the author. Each post—or tweet—may be re-posted by other users for further dissemination across their network of “followers.” Tweets are designed to be teasers that lead to other content and give the users the ability to quickly share content on a basic level that can then be linked to more blogs or more robust information sources. On Twitter® it is not necessary for a “follower” to be approved. This gives tweets the ability to spread virally throughout the network. As such, Twitter® has become an efficient and simple way to spread web content and information to a wide audience. Users of Twitter® create a profile, where their tweet history is recorded. There is also a feed where content can be liked, shared, and other users can send direct messages. The Twitter® platform did however change the landscape of social media by being the first to have a #hashtag on their site. A #hashtag is a method of categorizing a content with other related content so that users browsing through content are able to find additional information on the same topic or of a similar nature.

Although Twitter® can spread awareness of news, current events, and is relatively efficient at doing so, the inventor has recognized that there is no place on the network to convert people into supporters of content or donors for the sake of charitable giving. Furthermore, with the character limitation on Twitter®, web traffic is often redirected to other websites that are not necessarily involved in the social network, and therefore completely un-moderated and have no direct relations to the social affirmations received on Twitter®.

In the realm of photo sharing, Instagram® is an important platform. Like many other social networks a user creates a profile and builds a network of “friends” or “followers” to share their digital media. Unlike Facebook®, Instagram® is very specific to keeping a user's feed basic with only photo, video, and dialogue. Features like direct messaging and “likes” exist just like the other platforms. Instagram's® main niche is found in the filters, simplicity of design, engaging photo and video content, and the presence of “influencers” who use Instagram® as a platform to share products, travel, and lifestyle photos for the inspiration of other users of the platform. Developing a high number of followers has become a status symbol and monetization tool for content creators.

Again, in the case of Instagram®, people can follow the pictures and video content that is posted by their favorite charities, but organizations and individuals are not clearly differentiated on the platform, nor are the profiles robust enough to clearly communicate the goals and projects that a charity has. There are only links available in the description section of the profile, and like Twitter®, traffic is directed away from the platform when users seek further information.

YouTube® is the only social media platform that organically rewards content creators for posting to the platform. YouTube® is a unique platform that attempts to solve the problem addressed by the present disclosure in regards to content monetization and its position in social media. Building connections and networks on YouTube® can be done in many ways, including: Posting quality videos on a regular basis, making friends with others in your field, much like Facebook® you can send out friend requests on YouTube® to get subscribers; favorites and of course the capability to network with other users through comments and social sharing. YouTube® is a powerful platform for monetizing content and if a user wants to get paid by YouTube® they will need to drive traffic to their videos to see and click on Google's@ ads. In addition to generating great content that will make people want to subscribe to a specific channel and keep coming back to see more videos, the user will need to advertise their videos as widely possible. One can do this by posting links to new videos on their blog or website, as well as posting video links across all social networks.

While YouTube® is an incredibly valuable source for content writers it's deficiency as recognized by the inventor in relation to the present disclosure is that it has a specific niche of creating and sharing video content across the Internet. This means that should a charity, organization or regular user want to raise money they cannot directly accept donations from the platform. Also, and most importantly, the compensation that the content creator receives from their video is completely unrelated to the content of the video. It is based on the number of times an ad is viewed. People can create content that serves little to no function in society, but because it is clickbait, can deliver disproportionate amounts of compensation. Finally, the exchange of value is still indirect in that the person consuming the content is not the one compensating the content creator. The funds are being collected by Google® from the entity purchasing advertisements, and being re-distributed to the content creator. It is YouTube's@ algorithm that connects the content on the videos to the viewer, and thus does not care about the creation or monetization of original content, just the traffic the video generates. YouTube® is specifically in place to share media and not reward content.

### 3. Related Art—Crowdfunding Platforms

Online, web based platforms for crowdfunding are increasingly popular as a means of aggregating funds for the support of specific causes or projects. Most of these sites provide a platform for people to give or receive financial support from a large number of people giving (generally) smaller value donations. Crowdfunding sites typically meet the needs of fundraising niches and to be successful integrate easily with social media and networking platforms for maximum exposure and the broadest possible user base. Broadly, crowdfunding platforms operate on single lump sum donations and have processing and platform fees in the 5-10% range.

One of the most reputable sites for crowdfunding and early technology adopters is Kickstarter®. Kickstarter® helps artists, musicians, filmmakers, designers, business people, entrepreneurs and other creators find the resources and support they need to make their ideas a reality. Kickstarter® is a crowdfunding platform, however the niche they are best known for is product development and artistic related support. Kickstarter® does not have a social media element, and therefore requires their projects and products to be shared on other platforms. Therefore any and all affirmations or reactions to Kickstarter® projects are correlated, but since they are removed from the direct funding of the projects are not causal.

The most popular crowdfunding platform for charity and social philanthropy is GoFundMe®. GoFundMe® is the most recognized platform for “charity” specific crowdfunding. On GoFundMe® a user can build a campaign to ask for fundraising. Causes can be for anything from medical bills to mission work. Tragedy, loss, or financial hardships are commonly found attracting support on the GoFundMe® platform. Once a campaign is created, the user shares it through their social media channels where people in their network can follow a link back to GoFundMe® and give directly. Once a campaign closes, funds are disbursed to the beneficiary of the campaign.

While GoFundMe® has proven to be a consistent and a reputable source among donors, deficiencies still do exist in their model. There are many cases where a user might visit a project or a cause with the intent to give, but upon seeing that there is a $5 minimum donation, or that they need to enter their credit card information, they abandon the donation and return to the other platform to continue browsing their feed. As recognized by the inventor and described throughout the present disclosure, the quick nature of an affirmation directly connected to a currency would eliminate these problems. In addition, there is no direct link between the content shared and the donation of funds.

### BRIEF SUMMARY

The present disclosure contemplates various systems, methods, and apparatuses for overcoming the above drawbacks accompanying the related art. One aspect of the embodiments of the present disclosure is a non-transitory program storage medium on which are stored instructions executable by a processor or programmable circuit to perform operations for generating a graphical user interface for monetizing social affirmations. The operations include displaying, on a user feed of the graphical user interface, a post including summary information of a project for which monetary contributions are accepted, the post including a link to a project details page including detailed information of the project that is more detailed than the summary information, and displaying, within or adjacent to the post, a social affirmation button by which a user of the graphical user interface may indicate an affirmation of the project, the affirmation causing a fixed amount of a virtual currency to be transferred from a store of virtual currency associated with the user to a store of virtual currency associated with the project.

A user's interaction with the social affirmation button may cause the social affirmation button to change its appearance on the user feed to indicate that the affirmation has been made.

The operations may include displaying, on a virtual currency purchasing page, a payment tool by which a user of the graphical user interface may purchase an amount of the virtual currency (e.g. representative currency) in exchange for a real currency.

The operations may include displaying, on a user profile of a user who indicated an affirmation of the project, an indication of a total amount of virtual currency transferred by the user's interactions with social affirmation buttons of posts.

The operations may include displaying a new post tool by which a user of the graphical user interface may advocate for the project by creating the post. The post may include an indication of the user who created the post. The operations may include displaying, on a user profile of the user who created the post, an indication of a total amount of virtual currency transferred by user interactions with the post and/or an indication of a total amount of virtual currency transferred by user interactions with posts created by the user. The operations may include displaying, on a user profile of the user who created the post, a list of users who have indicated an affirmation of the project using the social affirmation button of the post and/or a list of users who have indicated affirmations of projects using social affirmation buttons of posts created by the user. The new post tool may include a search tool by which a user of the graphical user interface may search for a project for which to advocate.

The operations may include displaying, on a user profile of a user of the graphical user interface, a list of following users who are currently following the user such that posts created by the user appear on user feeds of the following users.

The operations may include displaying, on a user profile of a user of the graphical user interface, a list of followed users that the user is currently following such that posts created by the followed users appear on a user feed of the user.

The operations may include displaying, on a user profile of a user of the graphical user interface, a list of followed projects that the user is currently following such that posts associated with the followed projects appear on a user feed of the user.

The operations may include displaying, on the project details page, a list of users who have indicated an affirmation of the project using social affirmation buttons of posts associated with the project.

Displaying the social affirmation button may include displaying, within or adjacent to the post, a plurality of social affirmation buttons by which a user of the graphical user interface may indicate an affirmation of the project, the affirmation causing a different fixed amount of the virtual currency to be transferred depending on which of the plurality of social affirmation buttons the user interacts with.

The post may include a progress indicator indicating progress toward completion of a contribution goal of the project.

The project may be a charity.

Another aspect of the embodiments of the present disclosure is a method of generating a graphical user interface for monetizing social affirmations. The method includes displaying, on a user feed of the graphical user interface, a post including summary information of a project for which monetary contributions are accepted, the post including a link to a project details page including detailed information of the project that is more detailed than the summary information, and displaying, within or adjacent to the post, a social affirmation button by which a user of the graphical user interface may indicate an affirmation of the project, the affirmation causing a fixed amount of a virtual currency to be transferred from a store of virtual currency associated with the user to a store of virtual currency associated with the project.

Another aspect of the embodiments of the present disclosure is a system for generating a graphical user interface for monetizing social affirmations. The system includes a server in communication with a user device and a program storage medium on which are stored instructions executable by the server to perform operations for generating a graphical user interface for monetizing social affirmations, the graphical user interface accessible by the user device via a web browser or mobile application of the user device. The operations include displaying, on a user feed of the graphical user interface, a post including summary information of a project for which monetary contributions are accepted, the post including a link to a project details page including detailed information of the project that is more detailed than the summary information, and displaying, within or adjacent to the post, a social affirmation button by which a user of the graphical user interface may indicate an affirmation of the project, the affirmation causing a fixed amount of a virtual currency to be transferred from a store of virtual currency associated with the user to a store of virtual currency associated with the project.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows an example view of a social affirmation monetization graphical user interface (GUI) according to an embodiment of the present disclosure;

FIG. 2 shows another example view of the social affirmation monetization GUI, including a project details page;

FIG. 3 shows another example view of the social affirmation monetization GUI, including a virtual currency purchasing page;

FIG. 4 shows another example view of the social affirmation monetization GUI, including a virtual currency purchasing page;

FIG. 5 shows another example view of the social affirmation monetization GUI, including a new post tool;

FIG. 6 shows an example social affirmation monetization apparatus according to an embodiment of the present disclosure;

FIG. 7 shows example contents of a user data storage of the social affirmation monetization apparatus;

FIG. 8 shows example contents of a project data storage of the social affirmation monetization apparatus;

FIG. 9 shows an example operational flow according to an embodiment of the present disclosure, including operations related to a user's purchase of virtual currency;

FIG. 10 shows another example operational flow according to an embodiment of the present disclosure, including operations related to a user's affirmation of a project;

FIG. 11 shows another example operational flow according to an embodiment of the present disclosure, including operations related to a user's creation of a post;

FIG. 12 shows another example operational flow according to an embodiment of the present disclosure, including operations related to a user following a project or another user; and

FIG. 13 shows an example of a computer in which the social affirmation monetization apparatus of FIG. 6, the operational flows of FIGS. 9-12, and/or other embodiments of the disclosure may be wholly or partly embodied.

### DETAILED DESCRIPTION

The present disclosure encompasses various embodiments of systems, methods, and apparatuses for generating a graphical user interface (GUI) for monetizing social affirmations. The detailed description set forth below in connection with the appended drawings is intended as a description of the several presently contemplated embodiments of these methods, and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

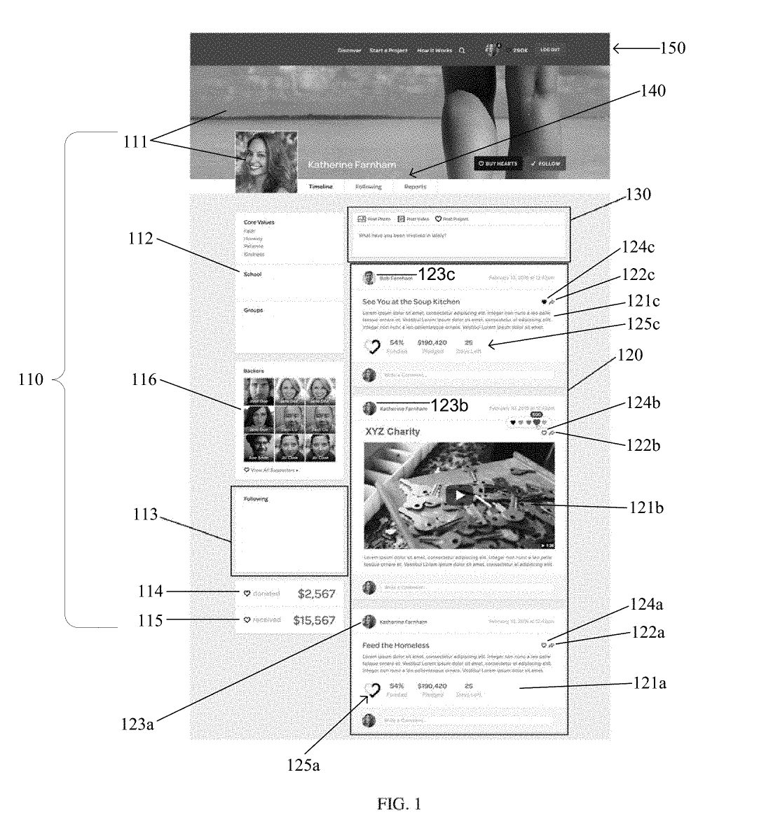

FIG. 1 shows an example view of a social affirmation monetization GUI 100 according to an embodiment of the present disclosure. Using the social affirmation monetization GUI 100, a user wishing to make a donation to a charity or other project may do so simply by indicating affirmation (e.g. clicking on a heart icon) of a post 121 (e.g. 121a, 121b, 121c) associated with the project. A user wishing to advocate for a given project may create such a post 121 and watch as the value of his/her advocacy is tracked by the social affirmation monetization GUI 100. FIG. 1 represents a user page of the social affirmation monetization GUI 100, which may include a user profile 110, a user feed 120, a new post tool 130, a navigation bar 140, and an information bar 150.

The user profile 110 may include any information about the user that the user may wish to share publicly or to a limited audience of following users (e.g. depending on privacy settings set by the user). The user profile 110 may, for example, include one or more still or video images 111 (e.g. a photo of the user), user profile information 112 such as core values, education, employment, groups, etc., follow information 113 such as projects that the user follows, other users that the user follows (i.e. followed users), and other users that follow the user (i.e. following users), and additional information 114, 115, 116 related to creating posts and indicating affirmations as described in more detail below.

The user feed 120 may include a series of posts 121 (e.g. 121a, 121b, 121c) presented in chronological order. In the example of the user feed 120 shown in FIG. 1, post 121a is associated with a project called “Feed the Homeless,” post 121b is associated with a project called “XYZ Charity,” and post 121c is associated with a project called “See You at the Soup Kitchen.” Each of the posts 121 may include summary information of the associated project, which may be in the form of a title, text, image, video, etc. as shown, along with a link 122 (e.g. 122a, 122b, 122c) to a project details page including detailed information of the project. The detailed information on the respective project details page may be more detailed than the summary information included in the post 121, with the post 121 itself only containing limited information in order to meet space constraints of the user feed 120 and enhance the impact of the post 121. As can be appreciated, focused summary information may allow a user to more quickly and easily gauge his/her interest in a project. In this regard, it should be noted that the post may further include an indication 123 (e.g. 123a, 123b, 123c) of the user who created the post 121. As will be described later in more detail, the summary information included in the post 121 may be created, in part, by the user who created the post 121 and thus may be specifically tailored to the user's audience of followers as part of the user's efforts to advocate for the project. As part of the summary information, the user may, for example, include a personalized message, for example, indicating that he/she will attend a particular event related to the linked project and encouraging other users to attend the event also and possibly meet up.

A social affirmation button 124 (e.g. 124a, 124b, 124c) may further be displayed within or adjacent to each post 121. By interacting with a social affirmation button 124 of a given post 121, a user of the graphical user interface may indicate an affirmation of the associated project. In addition to providing qualitative feedback to the person who created the post 121, the affirmation may cause a fixed amount of a virtual currency (e.g. hearts) to be transferred from a store of virtual currency belonging to the user who interacted with the social affirmation button 124 to a store of virtual currency belonging to the project associated with the post 121. In the example of the user feed 120 shown in FIG. 1, the social affirmation buttons 124 are heart icons that are initially unfilled (i.e. outline only) as in the case of the social affirmation button 124a, indicating that the user has not yet indicated an affirmation of the project. When the user clicks, taps, or otherwise interacts with the social affirmation button 121a, the heart icon may become filled, resulting in a filled heart icon as shown in the case of the social affirmation button 124c. In this way, the user's interaction with a social affirmation button 121 may cause the social affirmation button 121 to change its appearance on the user feed 120 to indicate that an affirmation has been made. By interacting with a social affirmation button 124 (e.g. “filling a heart”), a user may quickly affirm the project and post 121 while simultaneously donating to the project, all without leaving the user feed 120. The user may then move on to the next post 121. Thus, the user may browse his/her user feed 120 and make donations (e.g. microdonations) to several projects based on the merit of the projects and effectiveness of the posts 121. It is not necessary for the user to navigate to a page devoted to the project in order to make a donation.

The process of interacting with the social affirmation button 124 may be a single-step process (e.g. a single click) or may be a multi-step process (e.g. two clicks) as shown in the example of the social affirmation button 124b. Here, the first click causes a plurality of social affirmation buttons 124b to appear allowing the user to select between different fixed amounts of virtual currency (e.g. hearts) to transfer. As shown, the social affirmation buttons 124b may be color-coded to represent different amounts and there may be mouse-over text (e.g. “500” as shown) indicating the amount represented by each of the differently colored social affirmation buttons 124b. When the user finally selects an amount, the plurality of social affirmation buttons 124b may disappear and the single social affirmation button 124b may become filled as in the case of the social affirmation button 124c. In some cases, the social affirmation button 124b may become filled with the color of the selected social affirmation button 124b representing the amount transferred.

It is contemplated that a project that has already been affirmed by a user's interaction with a social affirmation button 124 of a first post 121 may later appear in the same user's feed in a second post 121 (e.g. posted by the same or a different user). In such cases, it is contemplated that the social affirmation button 124 of the second post may be displayed in an unfilled state, allowing the user to make a second donation, perhaps crediting a different user advocating for the project as described in more detail below. The social affirmation monetization GUI 100 may provide various ways for a user to check past donations and avoid unintended duplicate donations. For example, a user may review past user actions, including donations (e.g. sorted chronologically or by receiving project), using a “Timeline” button of the navigation bar 140 or may view a total amount donated to a given project using a “Reports” button of the navigation bar 140. As an alternative to the above situation, it is contemplated that the second post 121 described above may be initially displayed with a social affirmation button 124 that is already filled in or with some other indicator indicating that the user has already affirmed (and thus donated to) the project.

Each of the posts 121 may further include a progress indicator 125 (e.g. 125a, 125c) indicating progress toward completion of a contribution goal of the project. The progress indicator 125 may include, for example, a visual depiction of progress such as the partially filled heart outline shown in relation to posts 121a and 121c and/or various numerical measures of progress such as a percent funded (e.g. 54%), an amount of virtual or real currency pledged (e.g. $190,420), and a number of days left (e.g. 25). The number of days left may refer to the end of the project or to an end date of one of multiple contribution periods during the lifetime of the project. The visual depiction of progress and the percent funded may be determined based on a goal amount of virtual or real currency set for the project (e.g. by a person responsible for a user account associated with the project). As shown in the example of FIG. 1, some projects, such as charities (e.g. XYZ Charity), may not have a defined goal in some cases and thus the progress indicator 125 may be omitted from posts 121 associated with such projects.

Additional features of the user feed 120 may include, for example, a time/date stamp for each post 121 and a prompt to “Write a Comment.” associated with each post 121. By interacting with such a prompt, a user may begin or contribute to a discussion about the post, which may then be viewed and contributed to by other users of the social affirmation monetization GUI 100. In this way, a post 121 may serve as a jumping off point for a discussion across a social network regarding a project accepting contributions. Discussions may center around any topics and may, for example, include questions and answers about the project, user's personal experiences in relation to the project, plans to meet up at an event related to the project, feedback about the project, feedback about the post 121, etc.

The new post tool 130 may allow a user of the social affirmation monetization GUI 100 to advocate for a project by creating a post 121. As shown in FIG. 1, the new post tool 130 may include a button to post a project, thus associating the new post 121 with a project selected by the user. In addition, the new post tool 130 may include buttons to post a photo or a video as well as an open-ended field for providing summary information of the associated project as described above. When a new post 121 is created using the new post tool 130, the new post 121 may appear in the user's feed 120 as well as in other feeds 120 of other users who follow the user who created the post 121, or who follow the project associated with the post 121.

The navigation bar 140 may include various navigation buttons, such as the “Timeline” and “Reports” buttons mentioned above and a “Following” button as shown. These navigation buttons and/or drop-down menu entries thereof may serve as links to other pages of the social affirmation monetization GUI 100 as described throughout this disclosure. Various other functional buttons may be provided on the user page, for example, a “BUY HEARTS” button for navigating to a virtual currency purchasing page and a “FOLLOW” button for submitting a request to follow the user (which may or may not require approval by the user).

In the example of FIG. 1, a registered user is logged in, as reflected by the information in the right-hand portion of the information bar 150. A small circular portrait of the user represents the currently logged-in user, with a small number (e.g. “4”) indicating a number of unreviewed notifications for the user. Notifications may include, for example, a new following user, a new post 121 associated with a followed project, a new post 121 created by a followed user, a new donation made via a post 121 created by the user, etc. Clicking on the small circular portrait may allow the user to review such notifications and/or access a drop-down menu to navigate to various user-related pages of the social affirmation monetization GUI 100, e.g. pages for editing the user's profile 110, adjusting settings, etc. Next to the small circular portrait, an indication of the amount of virtual currency in the user's virtual currency store may be provided (e.g. 290K hearts), which may be clicked on to navigate to a virtual currency purchasing page. The registered user may log out by clicking the “LOG OUT” button. The information bar 150 may also include links to various information pages providing information about the social affirmation monetization GUI 100 (e.g. “Discover,” “Start a Project,” “How it Works”) as well as a search function (e.g. magnifying glass icon) that the user may interact with to open a search field for searching registered users, projects, website information, etc.

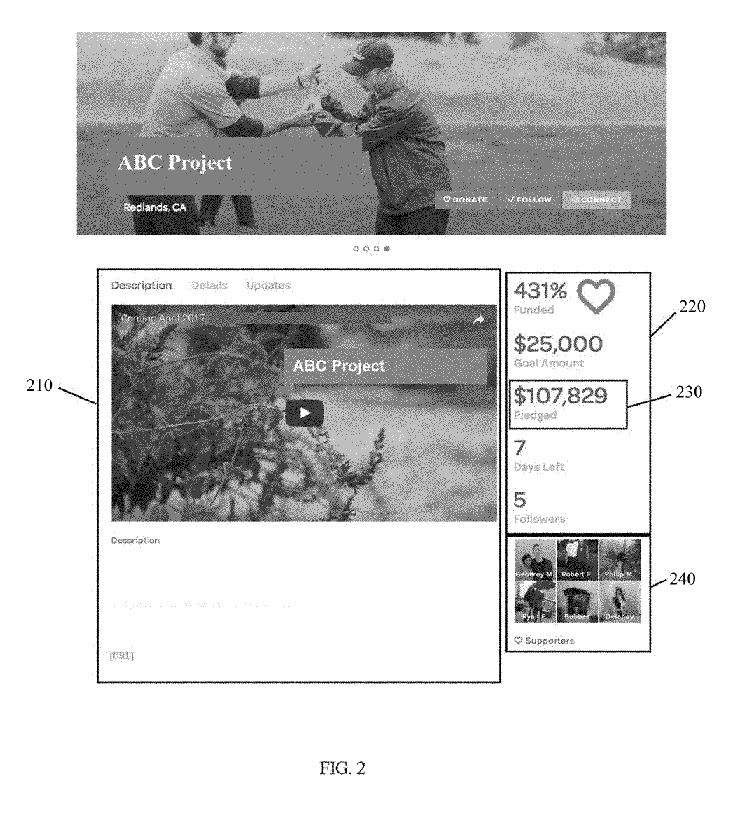

FIG. 2 shows another example view of the social affirmation monetization GUI 100, including a project details page. The project details page shown in FIG. 2 is for a project called “ABC Project” and may be accessed, for example, by clicking a link 122 included in a post 121 associated with “ABC Project.” For example, while browsing his/her feed 120, a user may see a post 121 associated with “ABC Project” and wish to learn more information about the project beyond what is described in the summary information of the post 121. The user may therefore click the link 122 to navigate to the project details page shown in FIG. 2. The project details page may include detailed information 210 of the project that is more detailed than the summary information included in the post 121. The detailed information 210 may include, for example, a video and/or images about the project (including, for example, a sliding banner as shown), a detailed description of the project, a URL of a website related to the project, a news feed or other display of current information about the project, e.g. recent updates, news stories, publications, etc. Some of the detailed information 210 may be available through tabs or other linked pages of the project details page (e.g. “Description,” “Details,” “Updates”). The project details page may also include contribution information 220 including, for example, a progress indicator that may be the same as (or more detailed than) the progress indicator 125 described in relation to FIG. 1, follower information such as the number of users following the project (e.g. “5 followers”), and/or a list of supporters 240. A supporter 240 may be a user of the social affirmation monetization GUI 100 who has indicated an affirmation of the project using a social affirmation button 124 of a post 121 associated with the project. Various buttons may be provided on the project details page, for example, a “DONATE” button for donating virtual or real currency to the project (e.g. from a user's virtual currency store in the same way as when donating via a social affirmation button 124), a “FOLLOW” button for submitting a request to follow the project, and a “CONNECT” button for contacting a user account associated with the project (e.g. to ask questions to a person in charge of the project).

The project details page may be a publicly accessible page created by a person responsible for a user account of the project. For example, a member, employee, officer, or other responsible person associated with a charity or other project may establish an account with the provider of the social affirmation monetization GUI 100. Such an account may be designated as a project account as opposed to an individual account (the accounts of users described throughout this disclosure) and may have access to different functionality and different pages of the social affirmation monetization GUI 100, such as creating/updating a project details page like the one shown in FIG. 2. By the creation of such an account (i.e. by registering a project with the social affirmation monetization GUI 100), exposure to the project may be increased as the project shows up in search results for users wishing to create posts 121. A post 121 linking to the project may then be shared across the social network made up of users of the social affirmation monetization GUI 100, with each user who views the post 121 being a potential donor to the project. Posts 121 linked to the project may thus “go viral,” resulting in more donations to the project and increased awareness of the cause. In view of content quality concerns, as well as legal and regulatory requirements involving donations to charities and other projects, it is contemplated that establishing a project account may require the approval of the provider of the social affirmation monetization GUI 100.

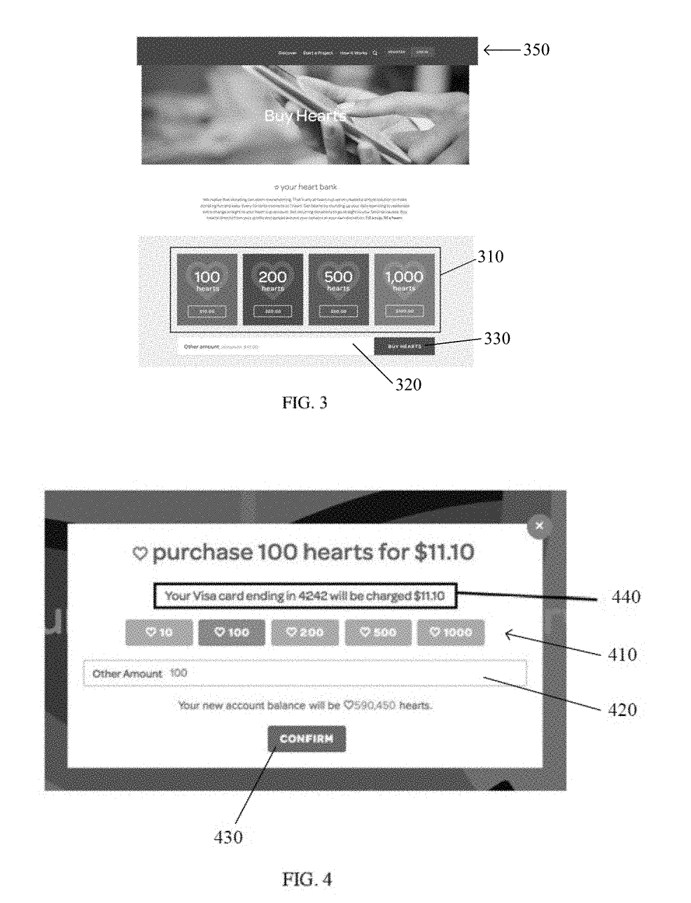

FIG. 3 shows another example view of the social affirmation monetization GUI 100, including a virtual currency purchasing page. Using the virtual currency purchasing page, a user of the social affirmation monetization GUI 100 may purchase an amount of virtual currency (e.g. hearts) in exchange for real currency. The virtual currency purchasing page shown in FIG. 3 may be accessed, for example, by interacting with the display of “290K hearts” in the information bar 150 shown in FIG. 1, by clicking the “BUY HEARTS” button shown in FIG. 1, etc. The virtual currency purchasing page may include buttons 310 for purchasing virtual currency in predetermined quantities (e.g. 100 hearts for $10.00, 200 hearts for $20.00, 500 hearts for $50.00, 1,000 hearts for $100.00), as well as a field 320 for entering an arbitrary quantity (which may itself be constrained by a minimum required quantity as shown). Having previously input payment information (e.g. credit card account, bank account, or cryptocurrency information) on an account settings page (not shown), a person may proceed with a purchase transaction by clicking one of the buttons 310 or by typing in another quantity using the field 320 and clicking the “BUY HEARTS” button 330.

FIG. 3 also shows an information bar 350, which may be the same as the information bar 150 shown in FIG. 1 except that, in the example of FIG. 3, the information bar 350 is representative of a logged-out state of the social affirmation monetization GUI 100. As such, the information bar 350 includes links for a new user to “REGISTER” or for an existing user to “LOG IN” in place of the user-specific links of the information bar 150 shown in FIG. 1.

FIG. 4 shows another example view of the social affirmation monetization GUI 100, including a virtual currency purchasing page. When a user makes a selection on the virtual currency purchasing page of FIG. 3, a pop-up window such as that shown in FIG. 4 may appear inviting the user to confirm his/her purchase selection. Such a pop-up window or other page may include, buttons 410 for modifying the purchase of virtual currency to a predetermined quantity (e.g. 10 hearts, 100 hearts, 200 hearts, 500 heart, 1000 hearts), a field 420 for modifying the purchase to an arbitrary quantity, and a “CONFIRM” button 430 for confirming the final amount. In addition, there may be one or more statements 440 summarizing the transaction to be confirmed, including, for example, information about the conversion between virtual and real currency, information about the resulting virtual currency store balance, etc. (“purchase 100 hearts for $11.10,” “Your Visa card ending in 4242 will be charged $11.10,” “Your new account balance will be 590,450 hearts”). The one or more statements 440 may include, for example, a total amount to be charged to a registered payment account (e.g. $11.10), which may include a fee (e.g. $0.10 or 11%) to be paid for the benefit of the provider of the social affirmation monetization GUI 100.

By using one or more virtual currency purchasing pages such as the virtual currency purchasing page of FIG. 3 and/or the virtual currency purchasing page of FIG. 4, a user may spend real currency to add virtual currency to their virtual currency store.

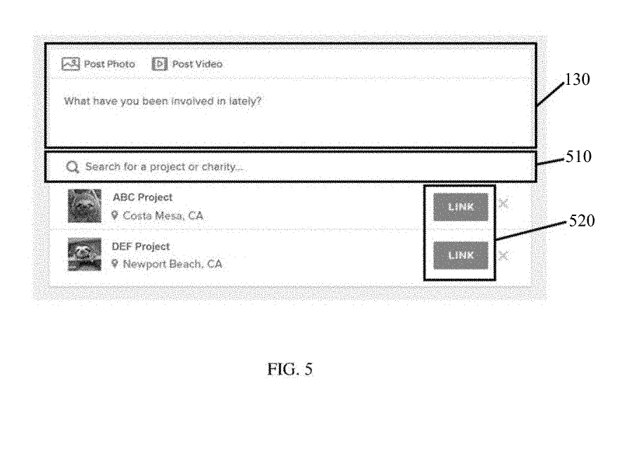

FIG. 5 shows another example view of the social affirmation monetization GUI 100, including a new post tool 130. By using the new post tool 130, a user of the social affirmation monetization GUI 100 may advocate for a project by creating a post 121. The new post tool 130 shown in FIG. 5 is a magnified view of the same new post tool 130 shown in FIG. 1, except that the user has clicked the “Post Project” button, revealing a search tool 510 by which the user may search for a project for which to advocate. The search tool 510 may include a search query entry field as shown (“Search for a project or charity . . . ”), allowing the user to type in a name of a project, one or more key words, or other search terms. Based on the user's entry in the search query entry field, a search may be conducted of projects having accounts with the social affirmation monetization GUI 100. The search may result in a hit when a project is found having one or more of the search terms in its name or project details. In the example of FIG. 5, the results of a search are displayed adjacent to the search query entry field and include two projects, “ABC Project” located in Costa mesa, CA and “DEF Project” located in Newport Beach, Calif. Project linking buttons 520 may be provided for each search result, which the user may use to select one of the projects to link to the post 121 being created, thus associating the post 121 with the selected project. Before or after linking a selected project with the post 121, the user may provide summary information of the project (which may include a personalized message from the creator of the post 121), etc. as described above. Once a project is linked with the post, a button to submit the post 121 (not shown) may appear, which the user may click to create the post 121, causing the newly created post to appear in user feeds 120 of users who follow the user who created the post 121 or who follow the project associated with the post 121. In this way, the user may broadcast a post 121 across their social network to advocate for the linked project.

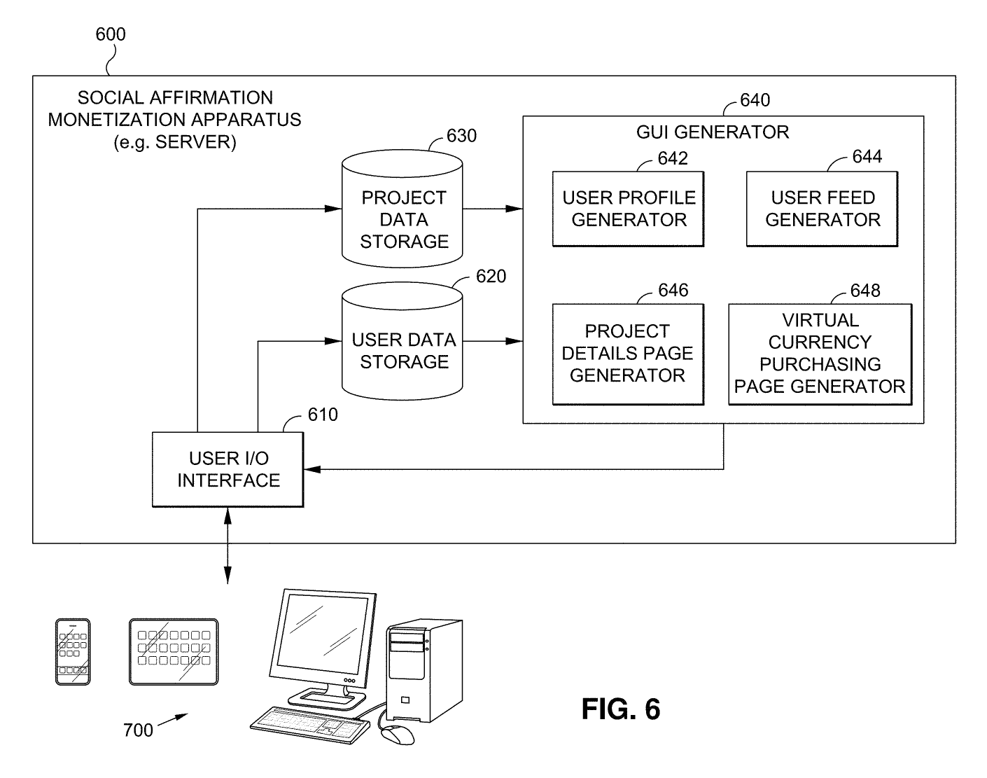

FIG. 6 shows an example social affirmation monetization apparatus 600 according to an embodiment of the present disclosure. The social affirmation monetization apparatus 600 may be a server or a combination of networked servers that interacts with a web browser or mobile application of a user device 700 in order to generate the social affirmation monetization GUI 100 described above. The social affirmation monetization apparatus 600 may include a user I/O interface 610, a user data storage 620, a project data storage 630, and a GUI generator 640.

The user I/O interface 610 may receive data from and transmit data to a web browser or mobile application of a user device 700. Input data may include, for example, user interaction data of a user with the social affirmation monetization GUI 100, such as social affirmations of posts 121 created by other users, requests to create new posts 121, project search queries as part of creating new posts 121 (e.g. using the new post tool 130 shown in FIGS. 1 and 5), requests to follow other users or projects, requests to purchase virtual currency (e.g. hearts), changes to user settings, etc. Output data of the user I/O interface 610 may include data to be interpreted by a web browser or mobile application in the generation of a display in accordance with the social affirmation monetization GUI 100 described herein. In this regard, it should be noted that the terms “display,” “populate,” etc. as used herein with respect to elements of the social affirmation monetization GUI 100 may include the outputting of data from the user I/O interface 610 or another component of the social affirmation monetization apparatus 600 for use by a user device 700.

Based on the received input data, the user I/O interface 610 may query and make various updates to data stored in the user data storage 620 and project data storage 630. In this regard, and as described in more detail below, the user data storage 620 and project data storage 630 may store all of the data relevant for generating the social affirmation monetization GUI 100 and managing the transfer of virtual currency between users and projects. On the basis of such data, as continually updated by user interactions with the social affirmation monetization GUI 100, the GUI generator 640 may generate the various pages of the social affirmation monetization GUI 100 described herein. The resulting updated social affirmation monetization GUI 100 may be continually fed back to the users as output data of the user I/O interface 610. The GUI generator 640 may include, for example, a user profile generator 642, a user feed generator 644, a project details page generator 646, and a virtual currency purchasing page generator 648 with functionality related to the various pages of the social affirmation monetization GUI 100 as described below.

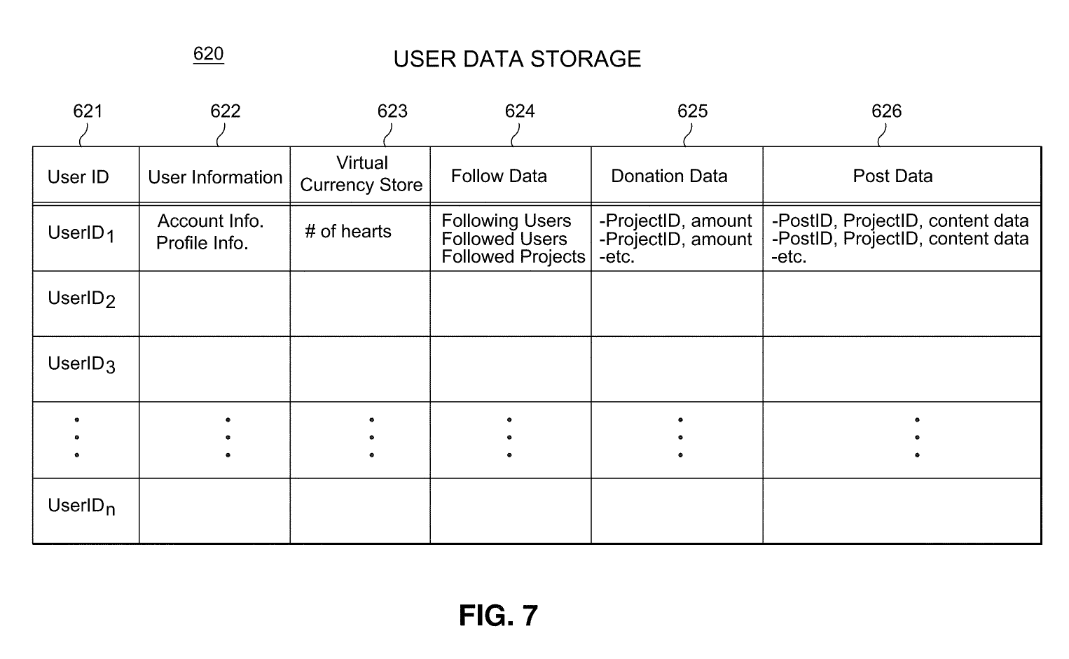

FIG. 7 shows example contents of the user data storage 620. As illustrated in tabular form by way of example, each of a plurality of user IDs 621 (UserID₁, UserID₂, UserID₃, . . . UserIDₘ) of individual accounts is stored in association with several items of data including, for example, user information 622, a virtual currency store 623, follow data 624, donation data 625, and post data 626. A user ID 621 may be a unique alphanumeric code assigned to an individual account registered with the social affirmation monetization apparatus 600.

The user information 622 may include, in association with each user ID 621, user account information such as identifying information, payment information, contact information, username, password, etc., which may be used to effectuate secure login to the social affirmation monetization GUI 100. The user information 622 may further include user profile information such as core values, school, groups, photos, etc. as shown in FIG. 1 or any other information about the user that the user may wish to share publicly or to a limited audience of following users (e.g. depending on privacy settings).

The virtual currency store 623 may include, in association with each user ID 621, an amount of virtual currency (e.g. hearts). The amount in the virtual currency store 623 may be increased, for example, by purchasing additional virtual currency using one or more virtual currency purchasing pages such as the virtual currency purchasing page of FIG. 3 and/or the virtual currency purchasing page of FIG. 4. The amount in the virtual currency store 623 may be decreased, for example, by indicating affirmations of projects using social affirmation buttons 124 of posts 121 in the user's feed 120 or by using a “DONATE” button on a project details page such as the project details page shown in FIG. 2.

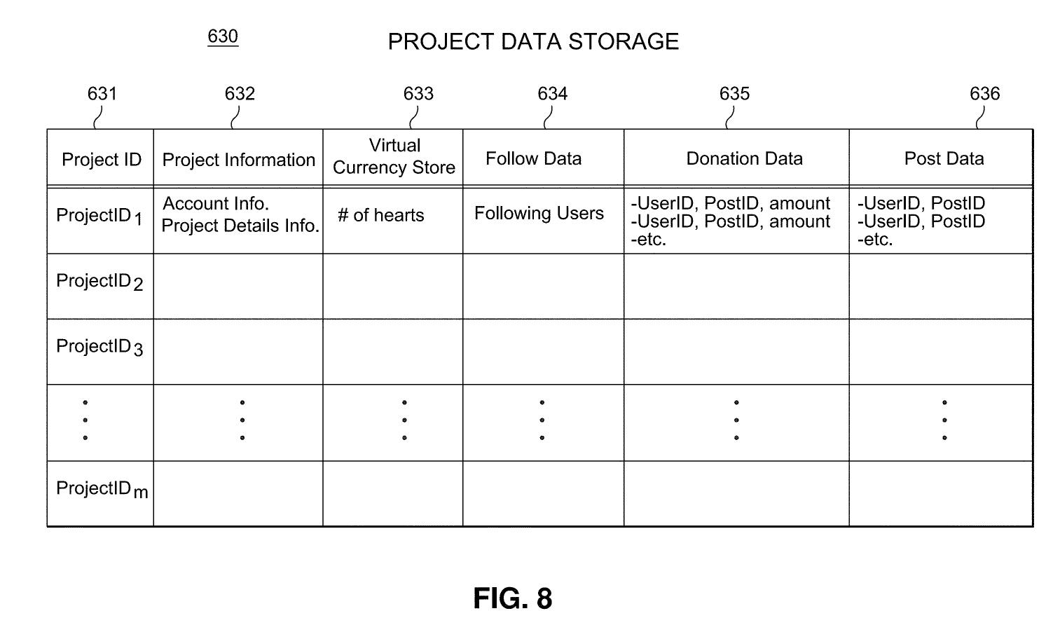

The follow data 624 may include, in association with each user ID 621, a list of following users, a list of followed users, and a list of followed projects. The list of following users may be a list of user IDs 621 of users who have chosen to follow the user. The list of followed users may be a list of user IDs 621 of users whom the user has chosen to follow. The list of followed projects may be a list of project IDs 631 (see FIG. 8) of projects that the user has decided to follow. The follow data 624 may be updated as users interact with the social affirmation monetization GUI 100 to follow other users and projects, e.g. using the “FOLLOW” button on the user page shown in FIG. 1 and the “FOLLOW” button on the project details page shown in FIG. 2, possibly but not necessarily after acceptance of a follow request by the user or project to be followed. The follow data 624 may be used by the user feed generator 644 of the GUI generator 640 to populate a user's feed 120 as described above. For example, the user's feed 120 may include (e.g. may consist of) posts 121 created by followed users and posts 121 associated with (i.e. linked to) followed projects.

The donation data 625 may include, in association with each user ID 621, information about donations made by the user, either by indicating affirmation of projects using social affirmation buttons 124 or by using a “DONATE” button on a project details page. For example, the donation data 625 may be organized as a list of project IDs 631 with corresponding amounts of virtual currency. The corresponding amount of virtual currency may represent the total amount donated by the user to the project having that project ID 631 and may be the result of multiple donations via multiple social affirmation buttons 124 of multiple posts 121.

The post data 626 may include, in association with each user ID 621, information about posts created by the user. For example, the post data 626 may be organized as a list of post IDs with corresponding project IDs and post content data (e.g. text of summary information provided by user, images, video, etc.). For example, upon creation of a new post 121 by a user using the new post tool 130, the social affirmation monetization GUI 100 may assign a post ID (e.g. a unique alphanumeric code associated with a specific post 121). The post ID may be stored as an entry of post data 626 for that user in the user data storage 620, in association with the project ID of the linked project and the content of the post 121. In this way, the user data storage 620 may include, for each user, a record of all posts 121 created by that user.

FIG. 8 shows example contents of the project data storage 630. As illustrated in tabular form by way of example, each of a plurality of project IDs 631 (ProjectID₁, ProjectID₂, ProjectID₃, . . . ProjectIDₘ) of project accounts is stored in association with several items of data including, for example, project information 632, a virtual currency store 633, follow data 634, donation data 635, and post data 636. A project ID 631 may be a unique alphanumeric code assigned to a project account registered with the social affirmation monetization apparatus 600.

The project information 632 may include, in association with each project ID 631, project account information such as identifying information of a user responsible for the account, payment information, contact information, username, password, etc., which may be used to effectuate secure login to the social affirmation monetization GUI 100. The project information 632 may further include project details information (including text descriptions, uploaded videos and photos, etc.) defining the content of a project details page associated with the project such as the project details page shown in FIG. 2.

The virtual currency store 633 may include, in association with each project ID 631, an amount of virtual currency (e.g. hearts). The amount in the virtual currency store 633 may be increased, for example, by receiving donations from users of the social affirmation monetization GUI 100, for example, by users indicating affirmations of the project using social affirmation buttons 124 of posts 121 or by users donating to the project using a “DONATE” button on a project details page such as the project details page shown in FIG. 2. While it is contemplated that the amount in the virtual currency store 633 may only increase without decreasing, thus representing a lifetime total of donations, it is also contemplated that the amount could periodically reset to zero or otherwise decrease. For example, in the case of a project that is a charity (rather than a short-term project having a defined lifetime), contribution goals may be set from time to time using the virtual currency of the social affirmation monetization GUI 100 with the amount in the virtual currency store 633 being reset to zero after achieving such goals. As another example, it is contemplated that the amount of virtual currency in the virtual currency store 633 may reflect a privately-tracked amount of virtual currency that has not yet been “cashed out” (e.g. converted to real currency paid by the provider of the social affirmation monetization GUI 100 for the benefit of the project). In such case, the amount may decrease when payment of real currency is made to the project. It is also possible for the virtual currency store 633 to store a combination of such values, such as a total of lifetime donations and an amount that has not yet been “cashed out.”

The follow data 634 may include, in association with each project ID 631, a list of following users. The list of following users may be a list of user IDs 621 of users who have chosen to follow the project. The follow data 634 may be updated as users interact with the social affirmation monetization GUI 100 to follow the project, e.g. using the “FOLLOW” button on the project details page shown in FIG. 2, possibly but not necessarily after acceptance of a follow request by the project to be followed. The follow data 634 may be used by the project details page generator 646 of the GUI generator 640 to display a number of followers on the project details page as described above.

The donation data 635 may include, in association with each project ID 631, information about donations made to the project by users of the social affirmation monetization GUI 100, either by indicating affirmation of the project using social affirmation buttons 124 or by using a “DONATE” button on a project details page of the project. For example, the donation data 635 may be organized as a list of user IDs 621, corresponding post IDs, and corresponding amounts of virtual currency. For each donation made to the project using a social affirmation button 124 of a post 121, an entry of donation data 635 may be made including the user ID 621 of the user who interacted with the social affirmation button 124 (thus donating virtual currency), the post ID of the post 121 whose social affirmation button 124 the user interacted with, and the amount of virtual currency donated. In some cases, a user may also donate to the project using a “DONATE” button on the project details page. Such donations may not correspond to any particular post 121. Therefore, entries of donation data 635 resulting from such donations may include only the user ID of the user who donated and the amount. However, entries of donation data 635 resulting from the use of a “DONATE” button on the project details page may in some cases include a post ID, such as where a user navigated to the project details page using a link 122 included in a post 121. In these instances, the creator of the post 121 may still get credit for the donation as described in more detail below. In a case where there is no post ID associated with a donation, it is further contemplated that such donations may be totaled for each user to combine into a single entry of donation data 635, rather than keeping track of separate times that a given user donated without an associated post 121.

The post data 636 may include, in association with each project ID 631, information about posts 121 associated with the project. For example, the post data 626 may be organized as a list of user IDs 621 of advocates, i.e. users who have created posts associated with the project, together with corresponding post IDs of the posts 121 they created. For example, upon creation of a new post 121 by a user using the new post tool 130, the social affirmation monetization GUI 100 may assign a post ID as noted above. The post ID may be stored in the project data storage 630 as an entry of post data 636 for the project associated with the post 121 (i.e. the project linked to the post 121). The entry of post data 636 may further include, in association with the post ID, the user ID 621 of the user who created the post 121. In this way, the project data storage 630 may include, for each project, a record of all posts 121 created for that project.

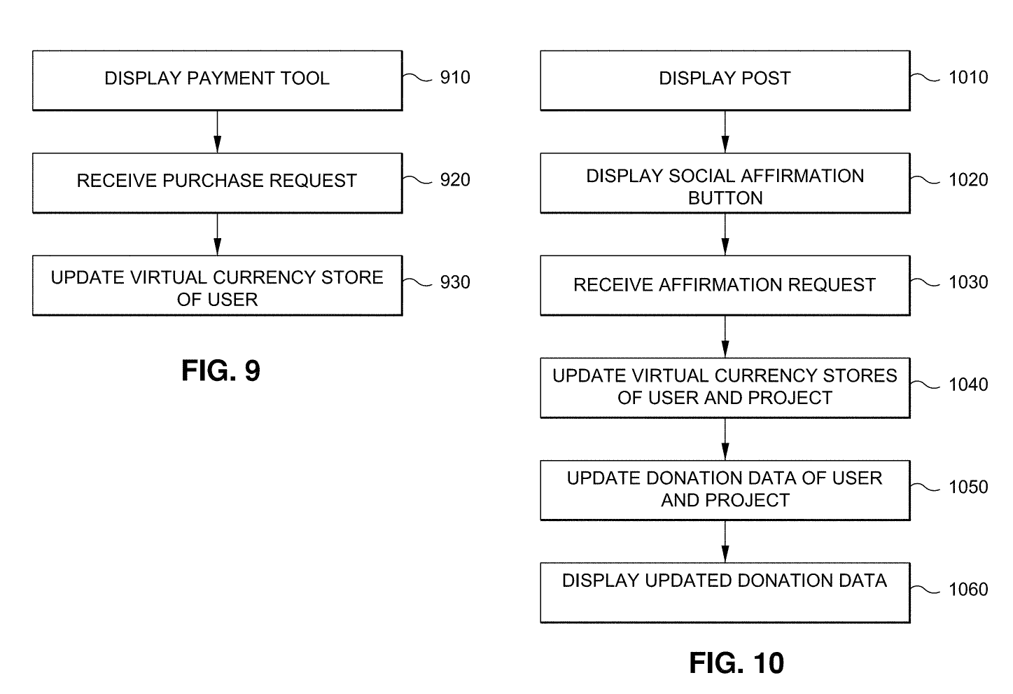

FIG. 9 shows an example operational flow according to an embodiment of the present disclosure, including operations related to a user's purchase of virtual currency. Referring by way of example to the social affirmation monetization GUI 100 shown in FIGS. 1-5 and the social affirmation monetization apparatus 600 shown in FIG. 6, the social affirmation monetization apparatus 600 may allow a user of the social affirmation monetization GUI 100 to purchase virtual currency as follows. First, the social affirmation monetization apparatus 600 may display a payment tool including a combination of buttons (e.g. buttons 310, 330, 410, 430) and entry fields (e.g. fields 320, 420) on a virtual currency purchasing page of the social affirmation monetization GUI 100 as shown in FIG. 4 or FIG. 5 (step 910). For example, the virtual currency purchasing page generator 648 of the GUI generator 640 may display the payment tool by causing relevant data to be output by the user I/O interface 610. The user I/O interface 610 may then receive a purchase request in response to user interaction with the payment tool over the user device 700 (step 920). The purchase request may be, for example, a request to purchase an amount of virtual currency such as 1000 hearts. The user I/O interface 610 may access the user data storage 620 to update the virtual currency store 623 of the user according to the purchase request (step 930), for example, to increase the amount of the virtual currency store 623 by 1000 hearts. Such updated amount of virtual currency may thereafter be usable by the user to donate to projects (e.g. by clicking social affirmation buttons 124) and the amount may be displayed on the social affirmation monetization GUI 100, for example, in the information bar 150 of the logged-in user as shown in FIG. 1.

FIG. 10 shows another example operational flow according to an embodiment of the present disclosure, including operations related to a user's affirmation of a project. Referring by way of example to the social affirmation monetization GUI 100 shown in FIGS. 1-5 and the social affirmation monetization apparatus 600 shown in FIG. 6, the social affirmation monetization apparatus 600 may allow a user of the social affirmation monetization GUI 100 to indicate an affirmation of a project, thereby donating virtual currency, as follows. First, the social affirmation monetization apparatus 600 may display, in the user's feed 120, a post 121 associated with (i.e. linked with) a project of interest to the user (step 1010). For example, based on the follow data 624 associated with the user ID 621 of the logged-in user, the user feed generator 644 of the GUI generator 640 may populate the user's feed 120 (e.g. by causing relevant data to be output by the user I/O interface 610) with posts 121 created by followed users or linked to followed projects. The social affirmation monetization apparatus 600 (e.g. the user feed generator 644) may further display a social affirmation button 124 such as a heart icon within or adjacent to each post 121 (step 1020).

When the user sees the posts 121 in his/her user feed 120, he may wish to donate to one of the projects using the social affirmation button 124 of one of the posts 121. The user I/O interface 610 may then receive an affirmation request in response to user interaction with the social affirmation button 124 of a selected post 121 over the user device 700 (step 1030). The affirmation request may include, for example, the post ID of the post 121 whose social affirmation button 124 was clicked, the project ID 631 of the project linked to the post 121, and a fixed amount of virtual currency such as 100 hearts (which may in some cases be designated by the user as described in relation to the social affirmation button 124b shown in FIG. 1). The user I/O interface 610 may, according to the affirmation request, access the user data storage 620 to update the virtual currency store 623 of the user, for example, to decrease the amount of the user's virtual currency store 623 by 100 hearts, and access the project data storage 630 to update the virtual currency store 633 of the project, for example, to increase the amount of the project's virtual currency store 633 by 100 hearts (step 1040). In this way, the user's interaction with the social affirmation button 124 may cause the transfer of virtual currency from the user's virtual currency store 623 to the project's virtual currency store 633.

The social affirmation monetization apparatus 100 may additionally, according to the affirmation request, update the donation data 625 of the user who made the affirmation request (step 1050). For example, in addition to updating the user's virtual currency store 623 in the user data storage 620, the user I/O interface 610 may update the donation data 625 associated with the same user ID 621. If the user has made donations to the same project in the past, the donation data 625 will include an entry having the project ID 631 of the project and some amount of virtual currency as shown in FIG. 7. The user I/O interface 610 may update the amount to reflect the new total including the new donation. If, on the other hand, the user has not made donations to this project, the user I/O interface 610 may add a new entry including the project ID 631 of the project and the amount of the donation. Thereafter, the user profile generator 642 of the GUI generator 640 may display the updated donation data 625 of the user when displaying the user profile 110 (step 1060). For example, as shown in FIG. 1, an indication 114 of a total amount donated by the user may be updated to reflect the total amount of the user's donations to all projects based on a summation of all entries of the donation data 625.

The social affirmation monetization apparatus 100 may additionally, according to the affirmation request, update the donation data 635 of the project affirmed by the affirmation request (step 1050). For example, in addition to updating the project's virtual currency store 633 in the project data storage 630, the user I/O interface 610 may update the donation data 635 associated with the project ID 631 of the request. The user I/O interface 610 may add a new entry including the user ID 621 of the user who made the donation, the post ID of the post 121 whose social affirmation button 124 was clicked, and the amount of virtual currency donated as shown in FIG. 8. Thereafter, the project details page generator 646 of the GUI generator 640 may display the updated donation data 635 of the project when displaying a project details page such as that shown in FIG. 2 (step 1060). For example, the total amount donated (or pledged) 230 and other elements of the contribution information 220 shown in FIG. 2 may be updated to reflect the total amount of all user's donations to the project based on a summation of all entries of the donation data 635. In addition, the list of supporters 240 may be updated to include all users whose user IDs 621 appear in the donation data 635 of the project, including the user who made the recent donation.

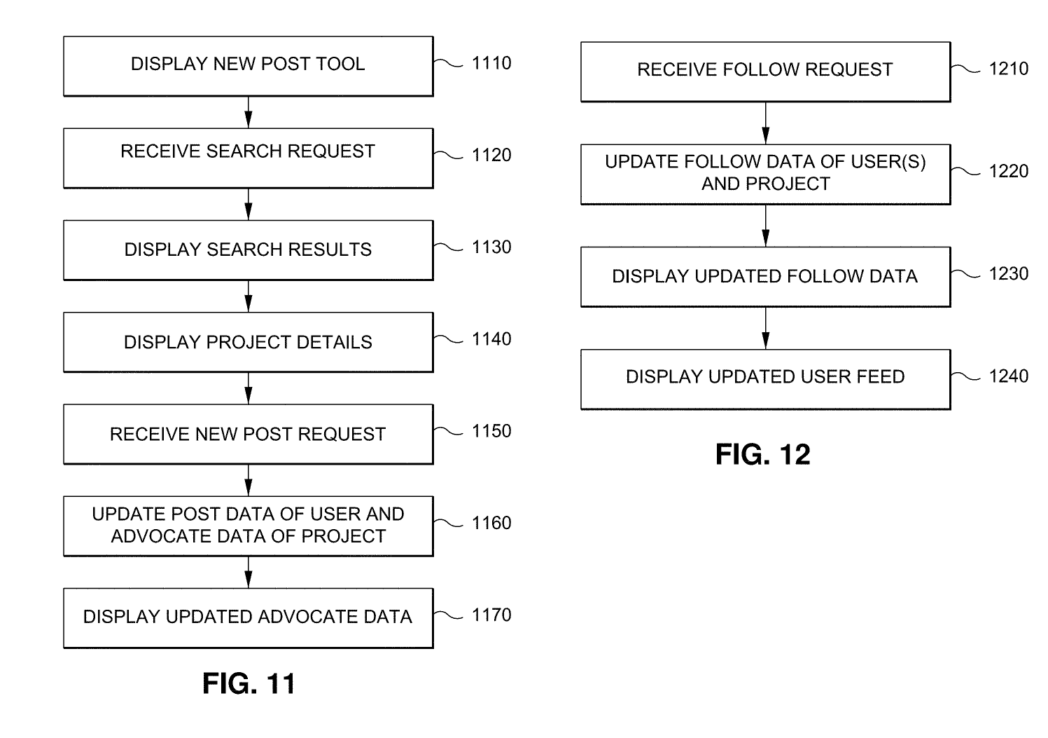

FIG. 11 shows another example operational flow according to an embodiment of the present disclosure, including operations related to a user's creation of a post 121. Referring by way of example to the social affirmation monetization GUI 100 shown in FIGS. 1-5 and the social affirmation monetization apparatus 600 shown in FIG. 6, the social affirmation monetization apparatus 600 may allow a user of the social affirmation monetization GUI 100 to create a post 121, thereby advocating for a project, as follows. First, the social affirmation monetization apparatus 600 (e.g. the GUI generator 640) may display a new post tool 130 (step 1110). The new post tool 130 may be displayed adjacent to the user feed 120 as shown in FIGS. 1 and 5.

When the user wishes to create a new post 121, the user may interact with various buttons and entry fields of the new post tool 130 to provide a photo, video, and/or text (e.g. summary information as described above) that will be included in the new post 121. To link the new post 121 to a project, the user may click the “Post Project” button, which may reveal a search tool 510 as shown in FIG. 5. The user I/O interface 610 may receive a search request in response to user interaction with the search tool 510 over the user device 700 (step 1120). The GUI generator 640 may then search the project data storage 630 according to the search request and populate the search tool 510 with search results as shown in FIG. 5 (step 1130). Each of the search results may represent a project having a project ID 631 stored in the project data storage 630 (i.e. a project registered with the social affirmation monetization apparatus 600). Before clicking on a project linking button 520 to select a project to be associated with the post 121, the user may wish to learn more about a project. To this end, it is contemplated that the search tool 510 may include functionality to allow the user to navigate to the project details pages of the projects listed as search results or to otherwise display project details (step 1140). For example, in some embodiments, a user may click on a given search result (e.g. the words “ABC Project” in FIG. 5) to navigate to a project details page such as the project details page shown in FIG. 2. In this case, the project details page generator 646 of the GUI generator 640 may display the project details by referring to the corresponding project information 632 in the project data storage 630. In order that the user does not lose the data of the new post 121 that he/she may have already partly entered into the new post tool 130, the project details page may open as a pop-up window or may include a button for conveniently navigating back to the new post tool 130.

After linking a selected project to the new post 121 (e.g. using a corresponding project linking button 520 of the search tool 510), the user may submit the newly created post 121, in response to which the user I/O interface 610 may receive a new post request (step 1150). The new post request may include, for example, the user ID 621 of the user submitting the request, the project ID 631 of the linked project, and content data of the new post 121 including any photos, videos, or text (e.g. summary information including any personalized message) provided by the user. The social affirmation monetization apparatus 100 may, according to the new post request, update the post data 626 of the user who made the affirmation request and update the post data 636 of the project linked to the newly created post 121 (step 1160). For example, the user I/O interface 610 may access the user data storage 620 and update the post data 626 associated with the user ID 621 of the user who created the new post 121, e.g., by adding a new data entry including the project ID 631 and content data of the request along with a newly generated post ID as shown in FIG. 7. The post ID may be generated by the user I/O interface 610 upon receipt of the new post request. The user I/O interface 610 may further access the project data storage 630 and update the post data 636 associated with the project ID 631 of the new post request, e.g., by adding a new data entry including the user ID 621 and the newly generated post ID as shown in FIG. 8.

The newly updated post data 626 in the user data storage 620 may be used by the social affirmation monetization apparatus 600 to display updated advocate data on various pages of the social affirmation monetization GUI 100 (step 1170), where advocate data may refer generally to data representative of the efforts of users in creating posts 121 to advocate for projects using the social affirmation monetization GUI 100. For example, the user profile generator 642 of the GUI generator 640 may display, on a user profile 110 of a user who has created one or more posts 121, an indication 115 (see FIG. 1) of a total amount of virtual currency transferred by user interactions with posts 121 created by the user. To generate the indication 115, the user profile generator 642 may first reference the user data storage 620 to create a project list of project IDs 631 associated with post data 626 of the user and a post list of post IDs associated with post data 626 of the user. The project list may represent all of the projects linked to posts 121 created by the user (i.e. all of the projects that the user has advocated for on the social affirmation monetization GUI 100). The post list may represent all of the posts 121 created by the user. Having created the project list and the post list, the user profile generator 642 may then reference the project data storage 630 using the project list. For each project ID 631 on the project list, the user profile generator 642 may query the donation data 635 for entries associated with any of the post IDs on the post list. By limiting the search using the project list in this way, it is not necessary to search the entire project data storage 630 and the search time can be reduced relative to a search of the entire project data storage 630. Each entry of donation data 635 found in this way includes an amount of virtual currency donated via a post 121 created by the user. By adding up all of the amounts, the user profile generator 642 may determine the total amount of virtual currency transferred by user interactions with posts 121 created by the user. The user profile generator 642 may display this amount (e.g. converted to real currency $15,567) on the user profile 110 as an indication 115 of the amount of virtual currency transferred by user interactions with posts 121 created by the user. In this way, the user's effectiveness in advocating for projects can be quantified and displayed for the user or for other users viewing the user's profile 110. The user may feel that he/she has “earned” the amount of $15,567 for the various projects he/she advocates for.

As described above, for each project ID 631 on the project list, the user profile generator 642 may query the donation data 635 for entries associated with any of the post IDs on the post list. In addition to adding up the amounts associated with these entries as described above, the user profile generator 642 may further create a list of the user IDs 621 associated with the same entries of donation data 635. Such list of user IDs 621 may represent all of the users who have donated via posts 121 created by the user (i.e. the user whose effectiveness in advocacy is being determined). The user profile generator 642 may then reference the user data storage 620 using the list of user IDs 621 in order to find relevant user information 622 corresponding to the user IDs 621. The user profile generator 642 may display the relevant user information 622, e.g. names and photos, on the user profile 210 of the user whose effectiveness in advocacy is being determined, for example, as a list of backers 116 as shown in FIG. 1. Thus, in the example of FIG. 1, each of the backers 116 listed in the user profile 110 of Katherine Farnham may represent a user who has donated via posts 121 created by Katherine Farnham.

It is further contemplated that project-specific or post-specific subtotal amounts of virtual currency can be calculated using the user data storage 620 and/or project data storage 630 in substantially the same way as described above. For example, in order to display an indication of a total amount of virtual currency transferred by user interactions with a user's posts 121 linked to a specific project, the above step of creating the project list can be omitted (as there is only one specific single project of interest). The user profile generator 642 may simply query the donation data 635 of the specific single project ID 631 of interest for entries associated with any of the post IDs on the post list. Each entry of donation data 635 found in this way includes an amount of virtual currency donated to the project of interest via a post 121 created by the user, which may be summed to generate the desired project-specific subtotal. Or, in order to display an indication of a total amount of virtual currency transferred by user interactions with a specific post 121 of interest, the above steps of creating the project list and creating the post list can both be omitted. The user profile generator 642 may simply query the donation data 635 of the specific single project ID 631 of interest for entries associated with the specific single post ID of interest. Each entry of donation data 635 found in this way includes an amount of virtual currency donated via the post 121 of interest, which may be summed to generate the desired post-specific subtotal.

Along the same lines, project-specific or post-specific sub-lists of backers 116 can be created. For example, in order to display a list of backers 116 who have transferred virtual currency to a specific project of interest via a user's posts 121, the step of creating the project list can be omitted. The user profile generator 642 may simply query the donation data 635 of the specific single project ID 631 of interest for entries associated with any of the post IDs of on the post list. Each entry of donation data 635 found in this way includes a user ID 621 of a user who donated to the project of interest via a post 121 created by the user whose effectiveness in advocacy is being determined. The user IDs 621 found in this way may be used to generate the desired project-specific sub-list of backers 116. Or, in order to display a list of backers 116 who have transferred virtual currency via a specific post 121 of interest, the steps of creating the project list and creating the post list can both be omitted. The user profile generator 642 may simply query the donation data 635 of the specific single project ID 631 of interest for entries associated with the specific single post ID of interest. Each entry of donation data 635 found in this way includes a user ID 621 of a user who donated via the post 121 of interest. The user IDs 621 found in this way may be used to generate the desired post-specific sub-list of backers 116.

Project-specific or post-specific subtotal amounts of virtual currency, as well as project-specific or post-specific lists of backers 116 are among the various advocacy reports contemplated to be displayable using the “Reports” button of the navigation bar 140 shown in FIG. 1. It is contemplated that the user may be able to export such advocacy reports, donation reports, etc. for use outside the social affirmation monetization GUI 100.

Continuing to refer to FIG. 11, the newly updated post data 636 in the project data storage 630 (see step 1160) may also be used by the social affirmation monetization apparatus 600 to display updated advocate data on various pages of the social affirmation monetization GUI 100 (step 1170). For example, while not shown in the example project details page of FIG. 2, a list of advocates for a project may be displayed on a project details page like the project details page of FIG. 2, where each advocate represents a user who has created at least one post 121 linked to the project. To generate such a list of advocates, the project details page generator 646 may first reference the project data storage 630 to create a list of user IDs 621 associated with post data 636 of the project. This list may represent all of the users who have created posts 121 linked to the project. Using such list of user IDs 621, the project details page generator 646 may then reference the user data storage 620 in order to find relevant user information 622 corresponding to the user IDs 621 on the list. The project details page generator 646 may display the relevant user information 622, e.g. names and photos, on the project details page as a list of advocates. In this way, a user's efforts in advocating for a project can be publicly recognized not only on the user's own profile 110 but on the project details page associated with the project. It is also contemplated that the project details page generator 646 may further reference the donation data 635 for the project to determine which user's posts 121 have generated the greatest amount of donations. The list of advocates on the project details page can then be organized as a ranked list showing “top advocates,” etc. according to a relative ranking or a predefined hierarchy of donation thresholds, giving further credit to the users who created the most effective posts 121.

FIG. 12 shows another example operational flow according to an embodiment of the present disclosure, including operations related to a user following a project or another user. Referring by way of example to the social affirmation monetization GUI 100 shown in FIGS. 1-5 and the social affirmation monetization apparatus 600 shown in FIG. 6, the social affirmation monetization apparatus 600 may allow a user of the social affirmation monetization GUI 100 to follow another user or project (causing related posts 121 to appear in the user's feed 120) as follows. First, the social affirmation monetization apparatus 600 may display a follow button such as the “FOLLOW” button on the user page shown in FIG. 1 or the “FOLLOW” button on the project details page shown in FIG. 2. Other places for a follow button are contemplated as well, for example, on each post 121 in a user's feed 120, where separate buttons may be provided to follow the user who created the post 121 or to follow the project linked to the post 121. The user I/O interface 610 may then receive a follow request in response to user interaction with a follow button over the user device 700 (step 1210).

The follow request may be, for example, a request to follow a specific user or a request to follow a specific project. When the request is to follow a user, the request may include a following (requester) user ID 621 and a followed user ID 621. The user I/O interface 610 may access the user data storage 620 to update the follow data 623 according to the follow request (step 1220), possibly after confirmation by the user to be followed. For example, the user I/O interface 610 may add an entry to the follow data 624 associated with the following (requester) user ID 621 designating the user ID 621 of the followed user as a “followed user.” The user I/O interface 610 may further add an entry to the follow data 624 associated with the followed user ID 621 designating the user ID 621 of the following user (requester) as a “following user.” On the other hand, when the request is to follow a project, the request may include a following (requester) user ID 621 and a followed project ID 621. The user I/O interface 610 may access the user data storage 620 and the project data storage 630 to update the follow data 623, 624 according to the follow request (step 1220), possibly after confirmation by the project to be followed. For example, the user I/O interface 610 may add an entry to the follow data 624 associated with the following (requester) user ID 621 designating the project ID 631 of the followed project as a “followed project.” The user I/O interface 610 may further add an entry to the follow data 634 associated with the followed project ID 631 designating the user ID 621 of the following user (requester) as a “following user.” Such updated follow data 624, 634 may thereafter be displayed on the social affirmation monetization GUI 100, for example, as follow information 113 in a user profile 110 as shown in FIG. 1 or as follower information associated with a project as shown in the project details page of FIG. 2. It is further contemplated that detailed follow information including following and followed users may be accessible via the “Following” button of the navigation bar 140.

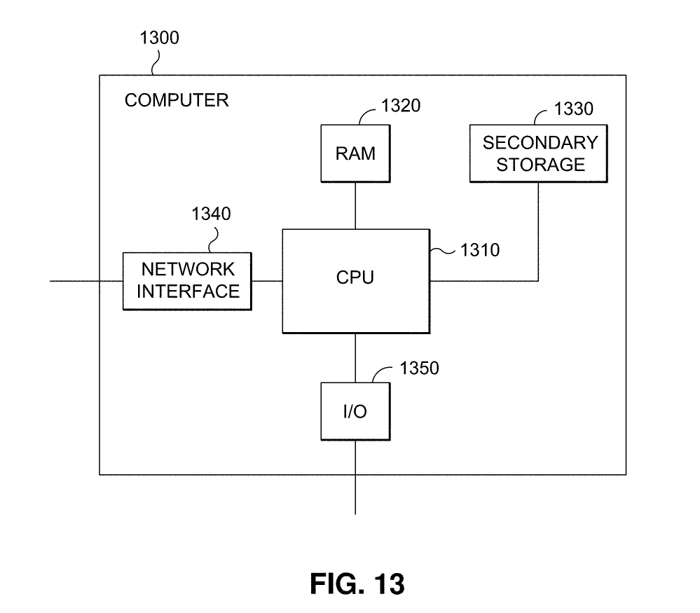

FIG. 13 shows an example of a computer 1300 in which the social affirmation monetization apparatus 600 of FIG. 6, the operational flows of FIGS. 9-12, and/or other embodiments of the disclosure may be wholly or partly embodied. As shown in FIG. 13, the computer 1300 may include a processor (e.g. CPU) 1310 and a system memory (e.g. RAM) 1320 that temporarily stores results of data processing operations performed by the processor 1310 and may be connected to the processor 1310 by a dedicated memory channel, as well as a secondary storage device 1330 such as a hard drive. The processor 1310 may execute one or more computer programs, which may be tangibly embodied together with an operating system on a computer-readable medium, e.g., the secondary storage device 1330. The operating system and the computer programs may be loaded into the system memory 1320 from the secondary storage device 1330 to be executed by the processor 1310. The computer 1300 may further include a network interface 1340 for network communication between the computer 1300 and external devices (e.g. over the Internet), such as user devices 700 accessing the social affirmation monetization GUI 100 described throughout this disclosure using a web browser or mobile application. Server-side user interaction with the computer 1300 may make use of one or more I/O devices 1350, such as a keyboard, mouse, display, etc.

The computer programs may comprise program instructions which, when executed by the processor 1310, cause the processor 1310 to perform operations in accordance with the various embodiments of the present disclosure. For example, a program that is installed in the computer 1300 may cause the computer 1300 to function as an apparatus such as the social affirmation monetization apparatus 600 of FIG. 6, e.g., causing the computer 1300 to function as some or all of the sections, components, elements, databases, storages, engines, interfaces, modules, generators, etc. of the apparatus 600 of FIG. 6 (e.g., the user I/O interface 610, the GUI generator 640, etc.). A program that is installed in the computer 1300 may also cause the computer 1300 to perform an operational flow such as those shown in FIGS. 9-12 or portions thereof, e.g., causing the computer 1300 to perform one or more of the steps of FIG. 10 (e.g., display post 1010, receive affirmation request 1030, update virtual currency stores of user and project 1040, etc.).

The above-mentioned program may be provided to the secondary storage 1330 by or otherwise reside on an external computer-readable medium such as a DVD-ROM, an optical recording medium such as a CD or Blu-ray Disk, a magneto-optic recording medium such as an MO, a tape medium, a semiconductor memory such as an IC card, a mechanically encoded medium such as a punch card, etc. Other examples of computer-readable media that may store programs in relation to the disclosed embodiments include a hard disk or RAM in a server system connected to a communication network such as a dedicated network or the Internet, with the program being provided to the computer 1300 via the network. Such program storage media may, in some embodiments, be non-transitory, thus excluding transitory signals per se, such as radio waves or other electromagnetic waves. Examples of program instructions stored on a computer-readable medium may include, in addition to code executable by a processor, state information for execution by programmable circuitry such as a field-programmable gate array (FPGA) or programmable logic array (PLA).

The disclosed embodiments of the social affirmation monetization GUI 100, social affirmation monetization apparatus 600, operational flows of FIGS. 9-12, etc. may constitute a platform that builds on existing similarities in the fields of social networking and charitable crowdfunding to realize the monetization of social affirmations through microdonations. Such a platform may be used to connect a user with his/her community through charities, organization, and other projects as well as through other individual users of the platform. Such a new platform of social interaction may be thought of as innovating on the behaviors of giving (time, money, advocacy) and tracking a user's impact within their social network. In light of the new approach to these social networking elements, the present disclosure posits that the monetization of social affirmations may facilitate the improvement of monetizing content creation in the context of social media and social networking and may spur a new form of incremental giving and create new behaviors of giving and advocacy within communities and social networks.

A platform in accordance with the disclosed embodiments may provide a vehicle for the collective network of users to collaborate and join in support of cause(s) to have a positive impact on the community. A user may can create a profile 110, define his/her core values, add friends, follow projects and other users, connect with other users to pursue volunteer opportunities, and build his/her profile through involvement in community and charitable organizations and other projects that support his/her values. A preferred profile 110 may be a long term record of an individual's social impact and a life resume of community involvement. The profile 110 may be where the record of giving, particularly through the monetization of social affirmations, is kept and communicated with the community.

Social media has become one of the world's most powerful tools to communicate, share and disseminate information. To date, the dominant model of monetization of online content has been through advertising. This has made the monetization indirectly related, yet correlated, to the production of content. By monetizing social affirmations, this brings direct monetary exchange through the sharing and dissemination of content. The technology encompassed by the disclosed embodiments has significant power to change lives. By such technology, a user's voice and social influence can lead to meaningful traction and fundraising for communities. A user of the contemplated platform can search for and tag any specific project on the platform and create a post 121 in a feed 120 where the user's followers can give to the project and further advocate for the project or request support. In the event of natural disaster or great need, such a platform has the potential to help many people in need.

As used herein, a project is intended to broadly encompass any project for which monetary contributions are accepted, from short-term projects (e.g. crowdfunding) having defined lifetimes and goals to charities and other organizations that persist indefinitely. Such organization-type projects may be separated into two distinct types, for-profit corporations and not-for-profit corporations. Not-for-profit corporations may be verified 26 U.S.C. 501(c)3 entities that have tax exempt status with the United States. In some cases, the monetization of social affirmations may only be available to for-profit institutions or individuals through the use of projects having defined lifetimes, while non-profits may have the ability to raise funds to directly support the operating costs of maintaining and running their organization. It is further contemplated that the disclosed social affirmation monetization GUI 100 may allow a user responsible for a project account to set the project either to accept or not to accept donations, with the monetization of social affirmations being implemented only for projects set to accept donations.

In the above examples of the social affirmation monetization GUI 100, social affirmations (e.g. “filling a heart” by clicking a social affirmation button 124) are monetized using a virtual currency such as “hearts” valued at $0.10 per heart. However, any currency, virtual or otherwise, may be used, including cryptocurrency. The social affirmations may simultaneously serve a function of indicating affirmation of the content, thus providing feedback to the content creator (e.g. project) and/or sharer (e.g. creator of the post 121) on the value or reaction to the content or post 121 they have provided to their network.

As described above, FIG. 1 may represent a user page of the social affirmation monetization GUI 100. In the example of FIG. 1, the user page is that of the currently logged-in user (“Katherine Farnham”) as shown in the information bar 150. It is contemplated that the logged-in user's own user page may serve as a home page of the social affirmation monetization GUI 100, where a user is directed upon login. A user may also navigate to user pages of other users, for example, by clicking on an indication 123 of a user who created a post 121, by clicking on a backer 116, by clicking on a following or followed user, by clicking on a supporter 240 on a project details page as shown in FIG. 2, etc. The user page of another user may be the same as the user page shown in FIG. 1 except that certain functionality may be added or omitted. For example, as shown in FIG. 1, the “FOLLOW” button includes a check mark, showing that the user has already been followed or may not be followed. In the case of FIG. 1 the logged-in user may not follow the user whose page is being viewed because they are the same user. When the logged-in user navigates to a user page of another user, the “FOLLOW” button may omit the check mark, include an unmarked check box, or otherwise indicate that following is permitted. The logged-in user may then click on the “FOLLOW” button to follow the user. As another example of the differences between a user's own user page and the user pages of others, a user may adjust privacy settings to hide certain user information 112 from other users according to a set of defined rules (e.g. visible to everyone, visible to followers, visible to no one, etc.). Thus, when the logged-in user navigates to a user page of another user, one or more items of user information 112 may not be visible.

As noted above with respect to the virtual currency purchasing pages of FIGS. 3 and 4, a user may input payment information (e.g. credit card account, bank account, or cryptocurrency information) on an account settings page of the social affirmation monetization GUI 100. Such payment information may be used by the provider of the social affirmation monetization GUI 100 to convert an individual account holder's real currency into virtual currency (e.g. hearts). In the same way, a user of a project account may also register payment information with the social affirmation monetization GUI 100, such as bank account or cryptocurrency information. Such payment information may be used by the provider of the social affirmation monetization GUI 100 to convert a project account holder's virtual currency (e.g. hearts) into real currency for the benefit of the project. It is by such conversions into real currency (e.g. withdrawals from a project's virtual currency store 633) that a project may receive actual monetary contributions, thus monetizing the social affirmations of the project.

Where possible, the steps of the operational flows shown in FIGS. 9-12 may be performed in any order or simultaneously in whole or in part. For example, in the case of FIG. 10, steps 1010 and 1020 may be performed simultaneously, as may steps 1040 and 1050.

Moreover, the data structures shown in FIGS. 6-8, including the user data storage 620 and project data storage 630 and the various data items therein, are provided only by way of example. Various other data structures are possible for implementing the features of the social affirmation monetization GUI 100. As such the particular steps described in relation to the operational flows FIGS. 9-12 may further vary depending on the data structures used.

Throughout the above description of the social affirmation monetization GUI 100, reference is made to various means of user interaction, including clicks, taps, etc. The disclosure is not intended to be limited to such specific interactions and any known user-device interactions may be applicable, including but not limited to keyboard, mouse, touch, gesture, voice, eye-tracking, etc.

In the above description of the social affirmation monetization GUI 100, affirmed content attached (linked) to a post 121 is in the form of a project (e.g. charity, crowdfunding, or other project) that is registered with the social affirmation monetization apparatus 600 and shared by the creator of the post 121. However, the disclosure is not intended to be limited to this specific example. More broadly, the content to be affirmed may be any kind of content, including artistic content (e.g. a video, photograph, or text), and the content may in some cases be created (rather than only shared) by the creator of the post 121. The creator of such content may be compensated by other users according to its quality through the social affirmation monetization GUI 100 described herein (e.g. using the social affirmation monetization buttons 124).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A non-transitory program storage medium on which are stored instructions executable by a processor or programmable circuit to perform operations for generating a graphical user interface for monetizing social affirmations, the operations comprising:
displaying, on a user feed of the graphical user interface, a post including summary information of a project for which monetary contributions are accepted, the post including a link to a project details page including detailed information of the project that is more detailed than the summary information; and
displaying, within or adjacent to the post, a social affirmation button by which a user of the graphical user interface may indicate an affirmation of the project, the affirmation causing a fixed amount of a virtual currency to be transferred from a store of virtual currency associated with the user to a store of virtual currency associated with the project.

2. The non-transitory program storage medium of claim 1 wherein a user's interaction with the social affirmation button causes the social affirmation button to change its appearance on the user feed to indicate that the affirmation has been made.

3. The non-transitory program storage medium of claim 1 wherein the operations further comprise displaying, on a virtual currency purchasing page, a payment tool by which a user of the graphical user interface may purchase an amount of the virtual currency in exchange for a real currency.

4. The non-transitory program storage medium of claim 1 wherein the operations further comprise displaying, on a user profile of a user who indicated an affirmation of the project, an indication of a total amount of virtual currency transferred by the user's interactions with social affirmation buttons of posts.

5. The non-transitory program storage medium of claim 1 wherein the operations further comprise displaying a new post tool by which a user of the graphical user interface may advocate for the project by creating the post.

6. The non-transitory program storage medium of claim 5 wherein the post includes an indication of the user who created the post.

7. The non-transitory program storage medium of claim 5 wherein the operations further comprise displaying, on a user profile of the user who created the post, an indication of a total amount of virtual currency transferred by user interactions with the post.

8. The non-transitory program storage medium of claim 5 wherein the operations further comprise displaying, on a user profile of the user who created the post, an indication of a total amount of virtual currency transferred by user interactions with posts created by the user.

9. The non-transitory program storage medium of claim 5 wherein the operations further comprise displaying, on a user profile of the user who created the post, a list of users who have indicated an affirmation of the project using the social affirmation button of the post.

10. The non-transitory program storage medium of claim 5 wherein the operations further comprise displaying, on a user profile of the user who created the post, a list of users who have indicated affirmations of projects using social affirmation buttons of posts created by the user.

11. The non-transitory program storage medium of claim 5 wherein the new post tool includes a search tool by which a user of the graphical user interface may search for a project for which to advocate.

12. The non-transitory program storage medium of claim 1 wherein the operations further comprise displaying, on a user profile of a user of the graphical user interface, a list of following users who are currently following the user such that posts created by the user appear on user feeds of the following users.

13. The non-transitory program storage medium of claim 1 wherein the operations further comprise displaying, on a user profile of a user of the graphical user interface, a list of followed users that the user is currently following such that posts created by the followed users appear on a user feed of the user.

14. The non-transitory program storage medium of claim 1 wherein the operations further comprise displaying, on a user profile of a user of the graphical user interface, a list of followed projects that the user is currently following such that posts associated with the followed projects appear on a user feed of the user.

15. The non-transitory program storage medium of claim 1 wherein the operations further comprise displaying, on the project details page, a list of users who have indicated an affirmation of the project using social affirmation buttons of posts associated with the project.

16. The non-transitory program storage medium of claim 1 wherein said displaying the social affirmation button includes displaying, within or adjacent to the post, a plurality of social affirmation buttons by which a user of the graphical user interface may indicate an affirmation of the project, the affirmation causing a different fixed amount of the virtual currency to be transferred depending on which of the plurality of social affirmation buttons the user interacts with.

17. The non-transitory program storage medium of claim 1 wherein the post includes a progress indicator indicating progress toward completion of a contribution goal of the project.

18. The non-transitory program storage medium of claim 1 wherein the project is a charity.

19. A method of generating a graphical user interface for monetizing social affirmations, the method comprising:
displaying, on a user feed of the graphical user interface, a post including summary information of a project for which monetary contributions are accepted, the post including a link to a project details page including detailed information of the project that is more detailed than the summary information; and
displaying, within or adjacent to the post, a social affirmation button by which a user of the graphical user interface may indicate an affirmation of the project, the affirmation causing a fixed amount of a virtual currency to be transferred from a store of virtual currency associated with the user to a store of virtual currency associated with the project.

20. A system for generating a graphical user interface for monetizing social affirmations, the system comprising:
a server in communication with a user device; and
a program storage medium on which are stored instructions executable by the server to perform operations for generating a graphical user interface for monetizing social affirmations, the graphical user interface accessible by the user device via a web browser or mobile application of the user device, the operations including:
displaying, on a user feed of the graphical user interface, a post including summary information of a project for which monetary contributions are accepted, the post including a link to a project details page including detailed information of the project that is more detailed than the summary information; and
displaying, within or adjacent to the post, a social affirmation button by which a user of the graphical user interface may indicate an affirmation of the project, the affirmation causing a fixed amount of a virtual currency to be transferred from a store of virtual currency associated with the user to a store of virtual currency associated with the project.
